(19) United States
(12) Patent Application Publication
(10) Pub. No.: US 2005/0240410 A1
(43) Pub. Date: Oct. 27, 2005

(54) Method and system for recognising a spoken identification sequence

(76) Inventors: Donald Michael Charles, Melbourne (AU); Ashley Clayton, Melbourne (AU)

Correspondence Address: HARNESS, DICKEY & PIERCE, P.L.C., P.O. BOX 828, BLOOMFIELD HILLS, MI, 48303, US

(21) Appl. No.: 10/502,415

(22) PCT Filed: Jul. 23, 2002
(86) PCT No.: PCT/AU02/00981

§ 371 Date: May 26, 2005

(30) Foreign Application Priority Data
Jul. 23, 2001 (AU) PR 6544

(51) Int. Cl. G10L 21/00

(52) U.S. Cl. 704/270

(57) ABSTRACT

A method for recognising a spoken identification sequence including one or more different types of identifiers, the spoken identification sequence having one of a plurality of possible predefined identifier type formats, the method including the steps of: (a) maintaining a database (3) of identification sequences having at least a first of said possible predefined identifier type formats, (b) establishing a connection between a caller (12) and a voice recognition system (2) operatively connected to the at least one database (3), (c) selecting one of said possible predefined identifier type formats, and (d) if the voice recognition system determines that the selected identifier type format corresponds to said first identifier type format providing said spoken identification sequence to the voice recognition system (2) for analysis according to the first identifier type format.

The present invention relates generally to methods and systems for recognition of spoken identification sequences, and in particular to the identification of spoken identification sequences having one of multiple possible predefined formats. The present invention is suitable for use in the identification of vehicle licence number plates, and it will be convenient to describe the invention in relation to that exemplary application. It is to be appreciated, however, that the invention is not limited to that application only.

Many institutions, such as banks and department stores, allow customers to access over a telephone network a wide variety of services. Before the advent of touch-tone telephones, a customer would obtain these services through interaction with a live customer services representative. As touch-tone telephones became more prevalent in homes, these institutions began switching to automated customer access systems. After dialling a telephone number, a customer using such systems would be asked to enter various numbers or identifiers in order to access the services provided by those institutions.

The next generation of automated customer access systems eliminated the use of a telephone keypad in at least part of the interaction with a caller, by the use of a speech recognition system that would prompt a caller to speak required identifiers into a telephone handset, and would then analyse the spoken identification sequence to determine the service requested by the caller.

However, exact correspondence between a recognised identification sequence and/an identification sequence spoken by a caller is difficult to attain. In particular, conventional telephone lines introduce signal noise and restrictive band width limitations into the spoken voice signal. Such a deterioration in the voice signal may cause a remote voice recognition system to produce a recognised output that does not correspond to a spoken identifier. These limitations may cause the voice recognition system to confuse similar sounding letters and numbers. Moreover, variations in the speech patterns, pronunciation and intonation of callers further limits the likelihood of successfully recognising identification sequence spoken by the caller.

It would therefore be desirable to provide a method and system for recognising a spoken identification sequence that enhances the reliability and performance of existing voice recognition systems.

It would also be desirable to provide a method and system for recognising a spoken identification sequence that has a high level of automation and minimises the time required to be spent with a live customer service representative.

It would also be desirable to provide a method and system for recognising a spoken identification sequence that ameliorates or overcomes one or more disadvantages of known voice recognition systems.

With this in mind, one aspect of the present invention provides a method for recognising a spoken identification sequence including one or more different types of identifiers, the spoken identification sequence having one of a plurality of possible predefined identifier type formats, the method including the steps of:

(a) maintaining a database of identification sequences having at least a first of said possible predefined identifier type formats,

(b) establishing a connection between a caller and a voice recognition system operatively connected to the at least one database,

(c) selecting one of said possible predefined identifier type formats, and

(d) if the voice recognition system determines that the selected identifier type format corresponds to said first identifier type format, providing said spoken identification sequence to the voice recognition system for analysis according to the first identifier type format.

In one embodiment of the invention, one type of identifier is a letter. Another type of identifier may be a number. In this way, the spoken identification sequence may comprise an alpha numeric sequence of characters.

In one embodiment, the identification sequence may be a vehicle licence plate number. The predefined identifier type format may comprise a combination of a series of one or more letters and a series of one or more numbers defining the vehicle licence plate number.

In a further embodiment, the method may include the step of the caller entering information via a telephone keypad in response to prompts for information from an interactive voice response system.

Another aspect of the invention provides a method for purchasing a pass for a toll road network, including the steps of:

recognising a spoken identification sequence according to the above-described method; and

purchasing the pass for use in conjunction with a vehicle associated with the spoken identification sequence. The identification sequence may correspond to a vehicle licence plate number.

Another aspect of the invention provides a method for recognising a spoken identification sequence including one or more different types of identifiers, the spoken identification sequence having one of a plurality of possible predefined identifier type formats, the method including the steps of:

(a) maintaining at least one database of identification sequences having at least a first of said possible predefined identifier type formats,

(b) selecting one of said possible predefined identifier type formats,

(c) determining that the selected identifier type format corresponds to one of the predefined identifier type formats, said determination being performed by a voice recognition system, and

(d) if the voice recognition system determines that the selected identifier type format corresponds to one of said predefined identifier type formats, providing said spoken identification sequence to the voice recognition system for analysis according to the predefined identifier type format.

The identification sequence may be a vehicle licence plate number. Thus a user, by enunciating a vehicle licence plate number as an identifier may, at the option of providing a password or other user identifier, obtain access to a further database that contains details of multiple registered licence plate numbers. Furthermore, the user may have access through this user identifier to details of one or more accounts maintained for each registered licence plate number, and may optionally modify selected accounts and/or registered licence plate numbers.

Alternatively the user, who may be a caller, can establish a connection to a voice recognition system connected to the at least one database and provide a spoken identification sequence which is recognised as corresponding to one of the predefined identifier type formats. In this way, any vehicle licence plate number, for example, can be spoken and recognised by the system.

A further aspect of the invention provides an information processing system for recognising a spoken identification sequence including one or more different types of identifier. The spoken identification sequence having one of a plurality of possible predefined identifier type formats, the system including at least one database of identification sequences having at least a first of said possible predefined identifier type formats, and a voice recognition system operatively connected to the at least one database and including a processing unit and associated memory means for storing computer program code for causing the processing unit to perform the steps of:

receiving one of said possible predefined identifier type formats selected by a caller, and

if the voice recognition system determines that the selected identifier type format corresponds to said first identifier type format, analysing said spoken identification sequence provided to the voice recognition system by the caller according to the first identifier type format.

Yet another aspect of the invention provides a voice recognition system forming part of the above described information processing system.

A further aspect of the invention provides a computer program including computer program code for use in conjunction with the above-described voice recognition system, the computer program code causing the above described processing unit to perform the above-mentioned steps.

The following description refers in more detail to the various features of the method and system for recognising a spoken identification sequence of the present invention. To facilitate an understanding of the invention, reference is made in the description to the accompanying drawings where the method and system for recognising a spoken identification sequence are illustrated in a preferred embodiment. It is to be understood however that the invention is not limited to the preferred embodiment as illustrated in the drawings.

In the drawings:

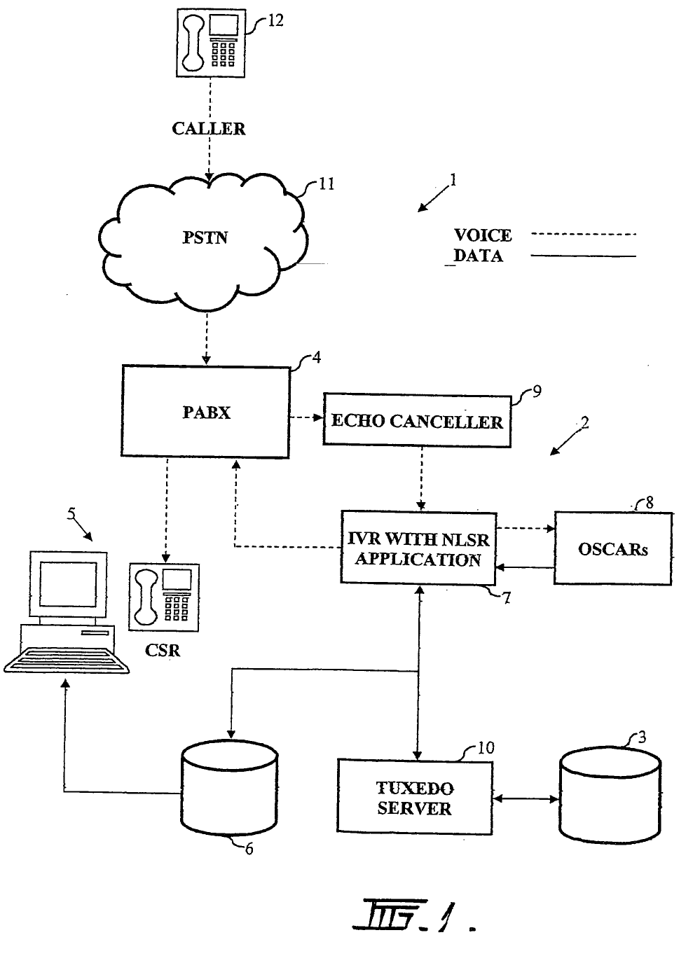

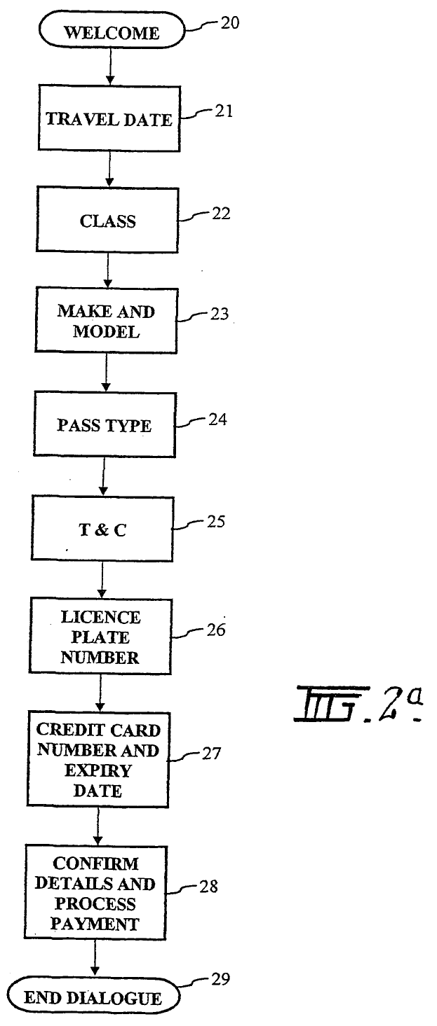

FIG. 1 is a schematic diagram illustrating one embodiment of an information processing system according to the present invention;

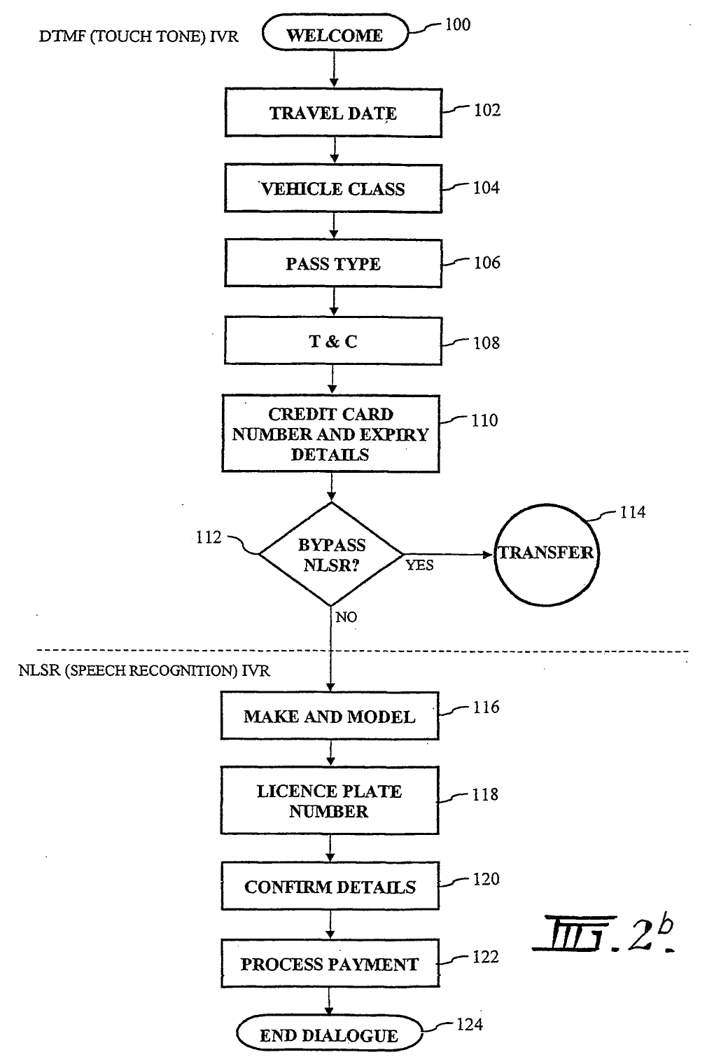

FIG. 2(a) is a flow chart illustrating the functional steps performed by the information processing system of FIG. 1 using speech recognition and interactive voice responses;

FIG. 2(b) is a flow chart illustrating the functional steps performed by the information processing system of FIG. 1 using a combination of telephone keypad input by a caller, speech recognition and interactive voice responses; and

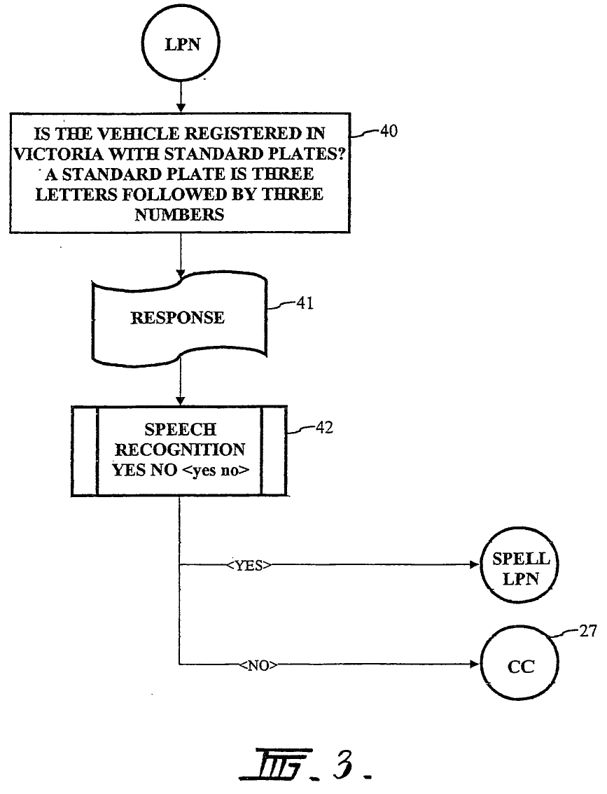

FIGS. 3 to 6 are flow charts illustrating the functional steps performed by the information processing system of FIG. 1 in the recognition of a spoken vehicle licence plate number forming part of the function steps depicted in FIG. 2.

Referring now to FIG. 1, there is shown generally an information processing system 1 including a voice recognition system 2, database 3, telephony switch 4, call centre 5 and computer/telephony integration system 6. The voice recognition system includes an interactive voice response system 7, a multi function speech processing platform 8, an echo canceller 9 and a transaction processing server 10. A telecommunications network 11 enables a caller 12 to establish a connection and interact with the information processing system 1.

In use, the caller 12 initially establishes a connection with the telephony switch 4 via the telecommunications network 11. The call is initially directed to the echo canceller 9 to eliminate or reduce the effect of an echo in the speech signal from the caller 12. The speech signal is then provided to the input of the interactive voice response system 7. A natural speech recognition application enables the interactive voice response system 7 to accept and interpret natural language speech input from the caller 12. The interactive voice response system 7 provides an output to the caller 12 in the form of prerecorded messages or computer generated speech, and accepts and interprets voice response inputs from the caller 12.

Processing of the speech signal from the caller 12 in response to the various prompts provided by the interactive voice response system 7 are processed and analysed by the multi function speech processing platform 8. The analogue speech signals provided at the input of the multi function speech processing platform 8 are converted into digital signals corresponding to predefined alpha numeric or other identifiers corresponding to a caller spoken signal. The interactive voice response system 7 provides an output to the telephony switch 4 in order to selectively divert calls from the caller 12 to the call centre 5 and handling by a live customer services representative.

The database 3 stores identification sequences of alpha numeric or other identifiers, such as vehicle licence plate numbers. The transaction processing server 10 acts to match a spoken identification sequence provided by a caller 12 with an identification sequence maintained in the database 3.

The computer/telephony integration system 6 acts to receive information captured by the interactive voice response system 7 and the transaction processing server 10 during interactions with the caller 12, and to provide this captured information as required to a customer services representative during a direct interaction with a caller 12.

The interactive voice response system 7, multi function speech processing platform 8 and transaction processing server 10 each include a processing unit and associated memory means for storing computer program code to cause each of these elements to perform the functionality illustrated in FIGS. 2(a), 2(b) and FIGS. 3 to 6. In particular, FIGS. 2(a), (2(b) illustrates a method for enabling the caller 12 to purchase a pass for a toll road network using the information processing system 1 shown in FIG. 1.

Initially, the caller 12 establishes a connection with the information processing system 1 by dialling in through the telecommunications network 11 and telephony switch 4. Upon establishment of the connection, the interactive voice response system 7 provides a computerised welcome message, at step 20 in FIG. 2(a), to the telephony switch 4 for transmission to the caller 12. At step 21, the user is prompted to provide the intended date on which they will be using the toll road network in question. Upon receipt of that date information, the caller 12 is then prompted to provide the class of the vehicle for which the pass is to be issued. At step 23, the caller is prompted to provide the make and model of the vehicle for which the pass is to be issued, and at step 24 whether the pass is to be for a predetermined period of time or for a predetermined portion of the toll road network only.

Having successfully provided the information at steps 21 to 24 required for a pass to be purchased, the interactive voice response system 7 provides computer generated speech to the telephony switch 4 for transmission to the caller 12 detailing the terms and conditions of the pass to be purchases. The information provided in steps 21 to 25 may be entered by the user either by conventional touch-tone data entry, or by simple interactions. with the interactive voice response systems 7. Many of these interactions require either a “yes” or “no” response from the caller 12, or require the caller 12 to provide one of a limited number of spoken word responses that are relatively easily distinguishable by the multi function speech processing platform 8.

At step 26, the caller 12 is prompted by the interactive voice response system 7 to provide the licence plate number of the vehicle for which the pass is to be purchased. Unlike the information provided by the caller 12 in response to prompts from the interactive voice response system 7 in steps 21 to 25, a vehicle licence plate number spoken by the caller 12 may be a numeric sequence of variable length, a sequence of letters of variable length, or both combined in a alpha numeric sequence. The number and position of each alpha numeric identifier in the licence plate number may also vary, as may the number of identifiers used in each vehicle licence plate number. Accordingly, the recognition of a spoken identification sequence corresponding to a vehicle licence plate number is difficult, and results in high error rates in known systems.

However, according to the present invention, prior to an analysis of a spoken identification sequence by the multi function speech processing platform 8, pre filtering of the vehicle licence plate number occurs. The possible predefined identifier type formats of various types of vehicle licence plate numbers that may be required to be recognised by the information processing system 2 are stored in the interactive voice response system 7. For example, a first type of vehicle licence plate number may have a predefined identifier type format consisting of a series of three letters followed by a series of three numbers. Other predefined identifier type formats may consist of one or more series of letters and/or numbers of differing lengths and positions.

By prompting the caller 12 to identify the predefined identifier type format in which the vehicle licence plate number is subsequently to be spoken, the task of recognising the vehicle licence plate number from the identification sequence spoken by the caller 12 is greatly facilitated.

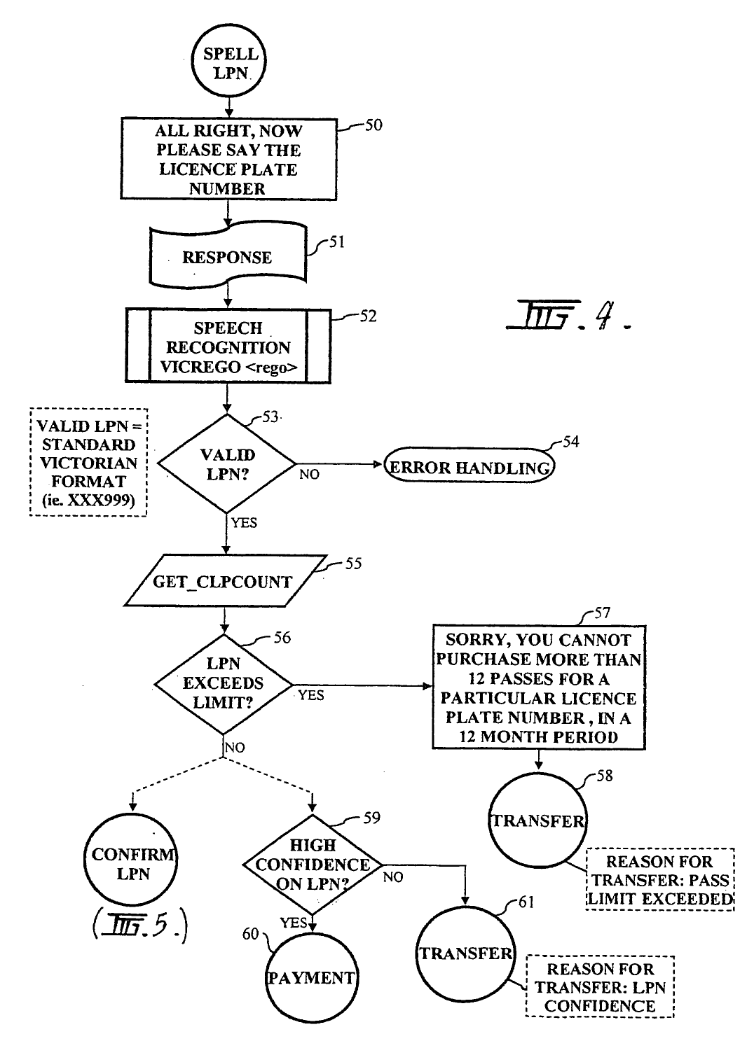

Accordingly, at step 40, in FIG. 3 the interactive voice response system 7 provides a computerised speech signal to the caller 12 asking, in this example, whether the vehicle for which the pass is to be issued has a vehicle licence plate number in a standard format of three letters followed by three numbers. Upon receiving the response from the caller 12 at step 41, and analysis of the “yes” or “no” response at step 42, the user is requested to spell the licence plate number (see FIG. 4), or alternatively this step is bi passed and a subsequent step in the process illustrated in FIG. 2(a), such as the entry of credit card details at step 27 is performed. The user is then able to purchase a pass for use in conjunction with a vehicle associated with the vehicle licence plate number (or other spoken identification sequence). The vehicle licence plate number may be provided to a customer service representative at the call centre 5 once information has been collected by the interactive voice response system 7 in relation to the other steps shown in FIG. 2.

At step 50 in FIG. 4, the caller 12 is prompted by the interactive voice response system 7 to speak the vehicle licence plate number. At step 51 the spoken identification sequence is provided by the caller 12, and analysed by the multi function speech processing platform 8 at step 52. In so doing, the spoken identification sequence provided by the caller 12 to the voice recognition system 2 is analysed according to the identifier type format indicated by the caller 12 in the response provided at step 41. If it is determined at step 53 that a valid licence plate number has not been provided, an error handling procedure is enabled at step 54. Otherwise, further processing of the request for a pass to the toll road network takes place.

At step 55, a data field recording the number of passes that have been issued to the caller 12 within a previous twelve month period is accessed. At step 56, a determination is made as to whether more than a predetermined number of passes have been issued during that period. If this is the case, the interactive voice response system 7 plays a computerised speech message to the caller 12 that that predefined limit has been exceeded, and information captured by the interactive voice response system 7 from the caller 12 is transferred to a customer service representative at the call centre 5 for further handling of the call, at step 58. If the number of passes issued to the caller 12 within the preceding twelve months has not exceeded a predefined limit, an assessment may be made at step 59 as to the degree of confidence in the recognition of the spoken identification sequence from the caller 12. Upon determination that the vehicle licence plate number has been identified with a high degree of confidence, payment for the toll road network pass may be initiated at step 60. Otherwise, the call, together with information captured by the interactive voice response system 7, may be transferred to a customer service representative of the call centre 5.

FIG. 2(b) shows an alternative process to that shown in FIG. 2(a) for purchasing a pass for a toll road network, using the information processing system 1 shown in FIG. 1. Again initially the caller 12 establishes a connection with the information processing system 1 by dialling on their telephone terminal using the telecommunications network 11 and telephony switch 4. Steps 100 through to 114 may be processed via telephone touch-tone data entry by the caller and interactive voice responses from the system 1. Thus at step 100, upon establishment of the connection the interactive voice response system 7 provides a computerised welcome message for transmission to the caller. At step 102 the user is prompted to enter the intended date of travel over the toll road network. Upon receipt of that date information, the caller 12, is then prompted to enter into their telephone terminal the class of the vehicle for which the pass is to be issued at step 104.

At step 106 the type of pass is prompted by the interactive voice response system 7 for entry by the caller, whether this is for a predetermined period of time or for a predetermined portion of the toll road network only. The terms and conditions of the pass to be purchased is recited back to the caller at step 108 whereby the system 7 provides computer generated speech to the telephony switch 4 for transmission to the caller 12. At step 110 the caller is then prompted by the system 7 to enter their credit card number and expiry details. At step 112 the caller is given the option of bypassing steps 116 to 124 which whereby natural language speech input from the caller is accepted and interpreted by the voice response system 7 in accordance with the processes undertaken with respect to FIG. 2(a). The caller has the option to be transferred to a customer representative at step 114 to continue to complete the process for obtaining a pass for the toll road network.

At step 116 the caller is prompted to provide the make and model of the vehicle for which the pass is to be issued, which is similar to step 23 in FIG. 2(a). At step 118 the caller is prompted to provide the licence plate number of the vehicle, similar to step 26 in FIG. 2(a) and then confirm the details at step 120. The payment is then processed by the system 1 at step 122 and at step 124 the process is complete.

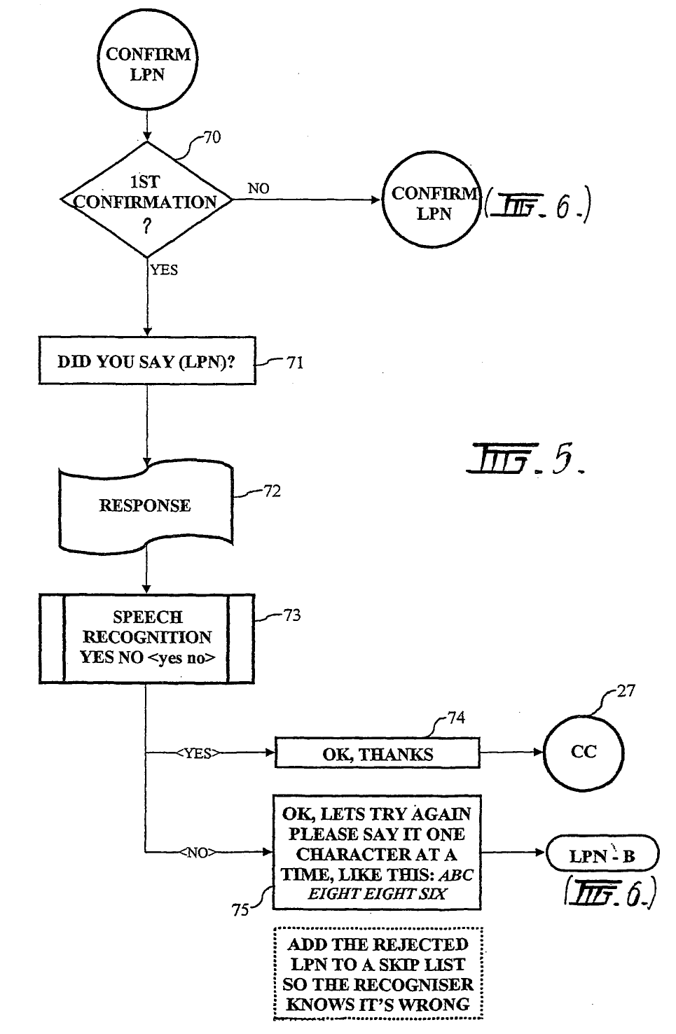

In an alternative embodiment, confirmation of the vehicle licence plate number may be requested. As seen in FIG. 5, an assessment may be made at step 70 as to whether this is the first confirmation to be performed. If so, the vehicle licence plate number recognised by the interactive voice response system 7 is played back to the caller 12 at step 71. A response as to whether this is the correct vehicle licence plate number is then provided by caller 12 at step 72, and interpreted at step 73 by the multi function speech processing platform 8. If the caller 12 confirms that the correct vehicle licence plate number had been interpreted, a message of thanks is played to the caller at step 74 and the identification of a credit card information for payment of the pass at step 27 proceeded with. Alternatively, a message requesting the caller 12 to repeat the vehicle licence plate number is played to the caller 12 at step 75, and a second attempt at confirmation occurs.

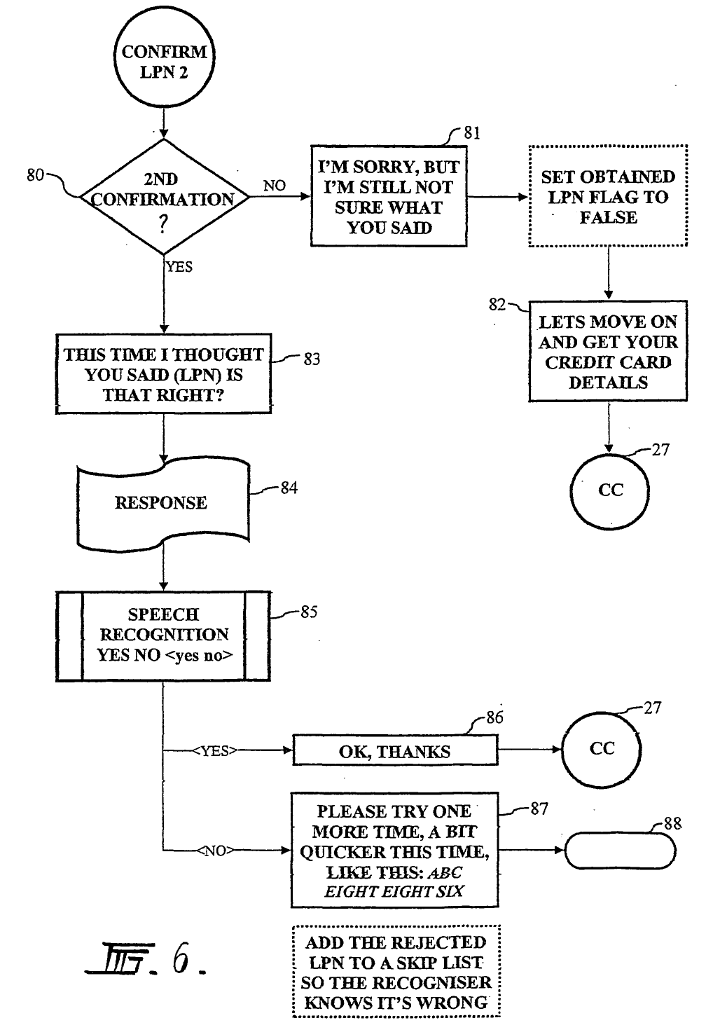

As seen in FIG. 6, the interactive voice response system 7 determines at step 80 whether this is the second confirmation attempt. If the second confirmation attempt has already been attempted unsuccessfully, a message is played at step 81 to the caller 12 indicating that identification of the vehicle licence plate number has been unsuccessful. At step 82, a further message is played to the caller 12 by the interactive voice response system 7, indicating that credit card details will subsequently be obtained from the caller 12, prior to the call being transferred to a customer service representative from the call centre 5 in order to obtain the vehicle licence plate number from a live interaction with that customer service representative.

Alternatively, if at step 80 was determined that this was the second attempt at confirmation, the voice response provided by the caller 12 is analysed, and replayed to the caller 12 at step 83. A voice input provided by the caller 12 at step 84 is then analysed at step 86 to determine whether the caller 12 has confirmed correct recognition of the vehicle licence plate number. If the caller 12 has indicated “yes”, a message of thanks is played to the user at step 86. If the caller 12 has indicated “no”, a further message is played to the user at step 87 requesting that the user repeat the vehicle licence plate number. Recognition of the vehicle licence plate number is then re attempted at step 88.

Finally, it is to be understood that various modifications and/or additions may be made to the method and system for recognising a spoken identification sequence without departing from the spirit or ambit of the present invention as defined hereabove.

1. A method for recognising a spoken identification sequence including one or more different types of identifiers, the spoken identification sequence having one of a plurality of possible predefined identifier type formats, the method including the steps of:
(a) maintaining a database of identification sequences having at least a first of said possible predefined identifier type formats;
(b) establishing a connection between a caller and a voice recognition system operatively connected to the at least one database;
(c) selecting one of said possible predefined identifier type formats and
(d) if the voice recognition system determines that the selected identifier type format corresponds to said first identifier type format, providing said spoken identification sequence to the voice recognition system for analysis according to the first identifier type format.

2. A method according to claim 1, wherein one type of identifier is a letter.

3. A method according to claim 2, wherein another type of identifier is a number.

4. A method according to claim 2, wherein the spoken identification sequence comprises an alpha numeric sequence of characters.

5. A method according to claim 1, wherein the identification sequence is a vehicle licence plate number.

6. A method according to claim 5, wherein the predefined identifier type formal comprises a combination of a series of one or more letters and a series of one or more numbers defining the vehicle licence plate number.

7. A method according to claim 1, the method further including the step of:
the caller entering information via a telephone keypad in response to prompts for information from an interactive voice response system.

8. A method for purchasing a pass for a toll road network, including the steps of:
recognizing a spoken identification sequence; and
purchasing the pass for use in conjunction with a vehicle associated with the spoken identification sequence.

9. A method for recognising a spoken identification sequence including one or more different types of identifiers, the spoke identification sequence having one of a plurality of possible predefined identifier type formats, the method including the steps of:
(a) maintaining at least one database of identification sequences having at least a first of said possible predefined identifier type formats;
(b) selecting one of said possible predefined identifier type formats;
(c) determining that the selected identifier type format corresponds to one of the predefined identifier type formats, said determination being preformed by a voice recognition system; and
(d) if the voice recognition system determines that the selected identifier type format corresponds to one of said predefined identifier type formats, providing said spoken identification sequence to the voice recognition system for analysis according to the predefined identifier type format.

10. A method according to claim 9, wherein the identification sequence is a vehicle licence plate number.

11. A method according to claim 10, the method further including:
providing user access to a further database containing details of multiple registered licence plate numbers.

12. A method according to claim 11, wherein user access to said further database is facilitated upon providing a user identifier.

13. A method according to claim 11, the method further including:
providing user access to one or more accounts maintained for each registered licence plate number.

14. A method according to claim 13, the method further including:
enabling user modification of selected accounts and/or registered licence plate numbers.

15. A method according to claim 9, the method further including:
the user establishing a connection to a voice recognition system connected to the at least one database, and providing a spoken identification sequence which is recognised as corresponding to one of the predefined identifier type formats.

16. An information processing system for recognising a spoken identification sequence including one or more different types of identifier, the spoken identification sequence having one of a plurality of possible predefined identifier type formats, the system including:
at least one database of identification sequences having at least a first of said possible predefined identifier type formats; and
a voice recognition system operatively connected to the at least one database and including a processing unit and associated memory means for storing computer program code for causing the processing unit to perform the steps of:
receiving one of said possible predefined identifier type formats selected by a caller; and
if the voice recognition system determines that the selected identifier type format corresponds to said first identifier type format, analysing said spoken identification sequence provided to the voice recognition system by the caller according to the first identifier type format.

17. A voice recognition system forming part of an information processing system for recognising a spoken identification sequence including one or more different types of identifier, the spoken identification sequence having one of a plurality of possible predefined identifier type formats, the system including:
at least one database of identification sequences having at least a first of said possible predefined identifier type formats; and
wherein the voice recognition system is operatively connectable to the at least one database and includes a processing unit and associated memory means for storing computer program code for causing the processing unit to perform the steps of:
receiving one of said possible predefined identifier type formats selected by a caller; and
if the voice recognition system determines that the selected identifier type format corresponds to said first identifier type format, analysing said spoken identification sequence provided to the voice recognition system by the caller according to the first identifier type format.

18. The voice recognition system of claim 17 further comprising a computer program including computer program code, the computer program code causing the processing unit to perform the steps of receiving one of said possible predefined identifier type formats selected by a caller and analyzing said spoken identification sequence provided to the voice recognition system by the caller according to the first identifier type format.
